(19) United States
(12) Patent Application Publication
(10) Pub. No.: US 2018/0223087 A1
(43) Pub. Date: Aug. 9, 2018

(54) THERMOPLASTIC MOULDING COMPOUND CONTAINING MICROSPHERES HAVING SOLID MATERIAL PARTICLES

(71) Applicant: INEOS STYROLUTION GROUP GMBH, Frankfurt am Main (DE)

(72) Inventors: Achim BERNHARDT, Hainburg (DE); Felix RATTAY, Neuss (DE)

(21) Appl. No.: 15/325,648

(22) PCT Filed: Jul. 17, 2015
(86) PCT No.: PCT/EP2015/066426

§ 371 Date: Jan. 11, 2017

(30) Foreign Application Priority Data
Jul. 17, 2014 (EP) 14177396.0

(51) Int. Cl. C08L 25/06; C08K 7/28; C08K 9/02; C08K 3/08; C08L 25/12; C08L 33/12; C08L 51/04

(52) U.S. Cl. CPC C08L 25/06; C08K 7/28; C08K 9/02; C08K 3/08; C08K 2201/003; C08L 33/12; C08L 51/04; C08K 2003/0812; C08L 25/12

(57) ABSTRACT

The invention relates to a thermoplastic moulding compound containing a polymer matrix (A) and a plurality of microspheres (M), at least one solid material particle (F), preferably exactly one solid material particle (F), being arranged in the microspheres (M).

The present invention relates to a thermoplastic molding composition comprising a polymer matrix A and also a large number of microspheres M with, arranged in each of the microspheres M, at least one solid particle F, preferably in each case precisely one solid particle F. The invention further relates to a process for the production of the thermoplastic molding composition and also to moldings, foils or coatings produced from the thermoplastic molding composition of the invention.

Pigments and/or other special-effect materials are often added to polymers in order to produce specific optical effects, see Plastics Additives Handbook, H. Zweifel, 2001, pp. 813 ff. A metallic appearance is provided to a polymer by using metal particles for example in the form of flakes, an example being chopped aluminum foil, also known as aluminum glitter or aluminum squares by way of example, comparably with a pigment at high concentration.

KR 2011-0017086 discloses a synthetic resin composition which comprises a metallic pigment and hollow glass microspheres. The synthetic resin composition has excellent scratch resistance and also a metallic appearance and improved weld performance.

JP H06-8240 (1994) describes a process where reinforcing fibers made of glass, carbon, polyethylene, nylon or polypropylene are coated with a metallic film.

WO 03/040225 describes a thermoplastic molding composition with metallic luster comprising various admixtures of reflective metal flakes. Reflective-metal-flake particles of almost identical size and shape are used.

The known special-effect materials that provide an optical effect in a molding composition frequently fail to give a satisfactory result because the metallic effect to be achieved does not have a realistic appearance, the metallic luster that can be achieved is insufficient, and/or orientation of the particles used in the molding composition produces visible flow lines and weld lines in injection moldings.

When pigments and/or other added special-effect materials are processed in thermoplastic molding compositions, disruption of the desired metallic effect occurs in particular through orientation of the added special-effect materials when wall thicknesses change, and also when polymer fronts converge.

It is an object of the present invention to provide a thermoplastic molding composition, in particular styrene-copolymer molding composition, which comprises special-effect materials which have random spatial orientation (in the molding composition) and have no local or overall orientation in any preferential spatial direction.

The object is achieved via a thermoplastic molding composition, in particular styrene-copolymer molding composition, which comprises a polymer matrix A and also a large number of microspheres M with, arranged in each of the microspheres M, at least one, preferably precisely one, solid particle F.

Because the shape of the microspheres M is round, the microspheres M and the solid particles F comprised therein have random orientation in the thermoplastic molding composition, i.e. do not have orientation in any preferential spatial direction. For the purposes of the invention, round can also mean ellipsoid, but preference is given to a spherical shape. The microspheres M can be hollow or filled. If the microspheres M are hollow, there is at least one, preferably precisely one, solid particle F in the space within the microsphere M, said space preferably being inaccessible to the thermoplastic molding composition. The arrangement can have a plurality of solid particles F, or precisely one solid particle F, within a microsphere M. In order to ensure flexible arrangement of various solid particles F in relation to one another, the arrangement preferably has precisely one solid particle F in a microsphere M. The shell of the microsphere can be composed of organic material (e.g. thermoplastic polymer) or of inorganic material (e.g. glass). The microsphere can be hollow or comprise a fill material.

In a preferred embodiment the microspheres M in the thermoplastic molding composition have an unaltered spherical shape and the solid particles F are not spherical. The spherical shape of the microspheres M should also preferably be retained during production and optional further processing of the thermoplastic molding composition, so that flow of the thermoplastic molding composition does not produce any (preferential) spatial orientation of the microspheres M. In order that the solid particles F have large surface area (per unit of mass) and thus by way of example to maximize metallic luster, it is preferable that the solid particles F are not spherical.

In another preferred embodiment the polymer matrix A is composed of at least one transparent styrene (co)polymer. It is preferable that the refractive indices, which can be determined in accordance with DIN 53491: 1955-06, of a material for the polymer matrix A and of a material of the microspheres M differ from one another by less than 1.5%, preferably by less than 1.0%, with particular preference by less than 0.5%. It is thus possible to achieve an appropriate relationship between the indices of polymer matrix A on the one hand and material of the microspheres M (shell and optional fill material) on the other hand.

In order that the material of the microspheres M is not itself visible in the thermoplastic molding composition, but instead the optical effect derives to the greatest possible extent from the solid particles F, it is preferable to use microspheres M made of a material having a refractive index similar to that of the material of the polymer matrix A. By way of example, material used for the hollow spheres M (or for the shell) can be a polystyrene PS (e.g. from the producer Styrolution, Frankfurt), a polymethyl methacrylate (PMMA) or a PS-PMMA copolymer. When thermoplastic polymers are used, the quantity (mass) of this material is often small, e.g. less than 5% by weight, often less than 1% by weight of the entire molding composition.

Materials which can be used as bases of the thermoplastic molding composition are not only a polymer matrix A composed of transparent styrene (co)polymer, in particular SAN matrix and/or ASA copolymer, but also various high-molecular-weight or oligomeric compounds which when temperature is increased becomes soft once their glass transition temperature is exceeded. These can be thermoplastics, but in principle also natural products and pharmaceutical products.

In one embodiment of the invention, the thermoplastic molding composition comprises at least one impact-modified copolymer (such as ASA or ABS) or an impact-modified copolymer blend (such as PC/ASA), and also optionally other components. In one preferred embodiment the thermoplastic molding composition comprises at least one rubber-modified styrene-acrylonitrile copolymer, where the rubber component can be based on an acrylate-styrene-acrylonitrile copolymer (ASA) or on a polybutadiene.

In one particularly preferred embodiment, the thermoplastic molding composition comprises at least one rubber-modified styrene-acrylonitrile (SAN) copolymer with at least one acrylate-styrene-acrylonitrile (ASA) rubber with bimodal particle size distribution and average particle size of from 80 nm to 600 nm, the particle size also often being from 200 nm to 600 nm, and also an SAN matrix with from 25 to 35% by weight of AN content, preferably from 27% by weight to 33% by weight.

The person skilled in the art has been aware for many years of various thermoplastics that can be used.

Mention is made of the following by way of example: polyamides, polycarbonates, styrene polymers, styrene copolymers and mixtures of these polymers. Among the styrene copolymers that can be used in the invention are by way of example styrene/acrylonitrile copolymers (SAN), rubber-modified styrene copolymers, for example acrylonitrile/butadiene/styrene copolymers (ABS), acrylonitrile/acrylate/styrene copolymers (ASA). A mixture of SAN and ASA is also often used.

Other materials that can also be used alongside these are derivatives or variants of SAN polymers, of ABS polymers or of ASA polymers, for example materials based on alpha-methylstyrene or methacrylate, or materials comprising other comonomers, an example being a material known as MABS. It is also possible to use mixtures of two or more different styrene copolymers. It is moreover possible to use rubber-modified styrene copolymers based entirely or to some extent on other rubbers, for example on ethylene-butadiene rubbers or on silicone rubbers.

Preference is also given to mixtures (blends) of the polymers mentioned with polyamides, with polybutylene terephthalates and/or with polycarbonates. Details of other thermoplastic molding compositions are listed below.

In another preferred embodiment, the microspheres M comprise, in particular as shell, at least 60% by weight, often at least 80% by weight, based on the entire material of the microspheres M, of glass. For the purposes of the invention glass is regarded as “polymerized silicate”, and the term polymerization is therefore also relevant during the production and shaping of glass. When styrene (co)polymers are used as material for the microspheres, in particular shells, the proportion by weight is often smaller.

In another preferred embodiment, the microspheres M have at least 60% by weight content, based on the entire material of the microspheres M, of a main material selected from a group consisting of: uncrosslinked polymers, for example polystyrene (PS), and crosslinked polymers, for example polymethyl methacrylate (PMMA), styrene copolymers and polycarbonate (PC). Main materials for the microspheres M are particularly preferably crosslinked polymers which in particular are PS/PMMA-based.

The microspheres M are often composed of at least 80% by weight of the main material, with particular preference at least 90% by weight. Not only the shell of the spheres but also their fill material can be composed of (optionally different) thermoplastic polymers.

In a preferred embodiment, the solid particles F comprise special-effect materials E, with the result that the solid particles F produce a special effect. Preference is given to metal particles as solid particles F. The use of metal particles provides a metallic appearance or a metallic coloring to the thermoplastic molding composition.

In another preferred embodiment the solid particles F have more than 60% by weight content, preferably more than 80% by weight and more preferably more than 90% by weight and with particular preference more than 98% by weight, of special-effect materials E. Materials particularly used as special-effect material E are aluminum, silver, copper and/or brass, but any of the substances that produce a metallic effect can be used as special-effect material E. In a particularly preferred embodiment, the solid particles F are metal particles, in particular metal platelets, e.g. aluminum platelets. For the purposes of the invention, metal particles are particles comprising more than 99% by weight of at least one metal or of an alloy.

In another preferred embodiment the solid particles F have a surface that reflects at least 40%, preferably 60% and with particular preference at least 70%, of the incident light. This is preferably a smooth surface that is highly reflective.

In another preferred embodiment, the solid particles F have a flat shape (an example being platelets) and the shortest spatial dimension is less than 5 μm, preferably less than 3 μm, and the longest spatial dimension is more than 5 μm, preferably more than 6 μm and less than 200 μm, preferably less than 100 μm, more preferably less than 50 μm and particularly preferably less than 20 μm. The solid particles F can be platelets, or else glitter, flattened spheres or flakes. It is particularly preferable to use aluminum flakes with a longest spatial dimension of (about) 8 μm.

In another preferred embodiment the average particle diameter of the microspheres is less than 200 μm, preferably less than 100 μm and particularly preferably less than 20 μm.

The largest spatial dimension of the solid particles F is precisely the same as or slightly (e.g. from 1 to 10%) smaller than the average particle diameter of the microspheres M. “Slightly” means in this context that there is no more than 30% difference between the magnitude of the greatest spatial dimension of the solid particles F and the average particle diameter of the microspheres M.

In a further preferred embodiment, the thermoplastic molding composition comprises, based in each case on the total weight of the thermoplastic molding composition, from 40% by weight to 95% by weight, often about 65% by weight to about 95% by weight, of the polymer matrix A comprising at least one transparent styrene (co)polymer, and also from 0.1% by weight to 30% by weight of solid particles F, preferably from 0.5% by weight to 5% by weight, and also optionally from 0.1% by weight to 4.9% by weight of auxiliaries and additives. The auxiliaries and additives here differ from the solid particles F and also differ from the material of the microspheres M. “Transparent” means that the polymer matrix A is permeable to visible light. The proportion of the microspheres (shell) depends on the material of which they are composed and can be small (e.g. <5% by weight) when polymer materials are used or higher (e.g. <10% by weight) when glass is used.

When quantities of solid particles F and, respectively, microspheres M are small, content of polymer matrix A in the molding composition can also be greater than 95% by weight.

The thermoplastic molding composition can comprise not only the polymer matrix A but also a further component B, a further component C, and/or a further component D.

Polymer matrix A used can be any polymer having thermoplastic properties. It is also possible to use a mixture of various polymer components A, for example SAN and ASA copolymers.

In particular, particulate rubbers are used as further component B. Particular preference is given to rubbers which have a grafted-on shell made of other, generally non-elastomeric, polymers. In one preferred embodiment of the invention, the graft rubbers, which are by way of example introduced in the form of partially dewatered material into an extruder, for example polybutadiene rubbers or acrylate rubbers, comprise up to 50% by weight of residual water, particularly preferably from 25% by weight to 40% by weight.

One embodiment of the invention consists in a process where graft rubbers of two- or multistage structure are used as further component B, where the elastomeric graft bases of these are obtained via polymerization of one or more of the monomers butadiene, isoprene, chloroprene, styrene, alkylstyrene, C1- to C12-alkyl ester of acrylic acid or of methacrylic acid and also of small quantities of other monomers including crosslinking monomers, and where the hard grafts are polymerized from one or more of the monomers styrene, alkylstyrene, acrylonitrile, methyl methacrylate.

Preference is given to graft particles made of polymers based on butadiene/styrene/acrylonitrile, n-butyl acrylate/styrene/acrylonitrile, butadiene/n-butyl acrylate/styrene/acrylonitrile, n-butyl acrylate/methyl methacrylate, n-butyl acrylate/styrene/methyl methacrylate, butadiene/styrene/acrylonitrile/methyl methacrylate and butadiene/n-butyl acrylate/methyl methacrylate/styrene/acrylonitrile. In the core or shell there can be up to 10% by weight of copolymerized polar monomers bearing functional groups, or else of copolymerized crosslinking monomers.

In one embodiment the following are used as polymer matrix A: styrene-acrylonitrile (SAN) copolymers, polystyrene, polymethyl methacrylate, polyvinyl chloride or a mixture of these polymers. Preference is given here to SAN polymers, polymethyl methacrylate (PMMA) or a mixture of these polymers.

The following materials can moreover also be used as polymer matrix A: polycarbonates, polyalkylene terephthalates such as polybutylene terephthalate and polyethylene terephthalate, polyoxymethylene, polymethyl methacrylate, polyphenylene sulfide, polysulfones, polyether sulfones and polyamides, and mixtures of these thermoplastics. It is moreover also possible to use thermoplastic elastomers such as thermoplastic polyurethane (TPU) as polymer matrix A.

The following can equally be used as polymer matrix A: copolymers based on styrene/maleic anhydride, on styrene/imidated maleic anhydride, on styrene/maleic anhydride/imidated maleic anhydride, on styrene/methyl methacrylate/imidated maleic anhydride, on styrene/methyl methacrylate, on styrene/methyl methacrylate/maleic anhydride, on methyl methacrylate/imidated maleic anhydride, on styrene/imidated methyl methacrylate, or on imidated PMMA or a mixture of these polymers.

In all of the embodiments mentioned of the polymer matrix A, the styrene can be replaced entirely or to some extent by alpha-methylstyrene, or by ring-alkylated styrene (or by acrylonitrile).

Among the last-mentioned embodiments of the polymer matrix A, preference is given to those based on alpha-methylstyrene/acrylonitrile, styrene/maleic anhydride, and styrene/methyl methacrylate, and to copolymers with imidated maleic anhydride.

Known examples of the further component B are polymers of conjugated dienes such as butadiene, with an exterior graft shell based on a vinylaromatic compound, for example on SAN copolymers. Materials likewise known are graft rubbers based on crosslinked polymers made of C1- to C12-alkyl esters of acrylic acid such as n-butyl acrylate, ethylhexyl acrylate, grafted with polymers based on vinylaromatic compounds such as SAN copolymers. Other familiar materials are graft rubbers which in essence comprise a copolymer of conjugated dienes and of C1- to C12-alkyl acrylates, for example a butadiene-n-butyl acrylate copolymer, and an exterior graft made of SAN copolymer, polystyrene or PMMA. Production of these graft rubbers by the conventional processes, in particular by emulsion polymerization or suspension polymerization, is known.

Graft rubbers based on SAN-grafted polybutadiene (ABS) are described by way of example in the documents DE 24 27 960 and EP-A 258 741, and graft rubbers based on SAN-grafted poly-n-butyl acrylate (ASA) are described by way of example in DE-B 12 60 135 and DE-A 31 49 358. Further details concerning SAN-grafted poly(butadiene/n-butyl acrylate) mixed rubbers can be found in EP-A 62 901.

The polymer matrix A can be produced by continuous bulk polymerization or continuous solution polymerization, where the resultant melt is continuously introduced directly to the extruder, for example by a melt pump, optionally after removal of the solvents. However, production via emulsion polymerization, suspension polymerization or precipitation polymerization is also possible, where the polymer is separated from the liquid phase in an additional operation step. Details of the production processes are described by way of example in Kunststoffhandbuch [Plastics handbook], ed. R. Vieweg and G. Daumiller, vol. V “Polystyrol” [“Polystyrene”], Carl-Hanser-Verlag, Munich, 1969, pp. 118 to pp. 124.

In the case of SAN-grafted polybutadiene, incorporation of the SAN produces a molding composition known as ABS (acrylonitrile/butadiene/styrene). If an SAN-grafted alkyl acrylate is used as polymer matrix A, the materials produced are known as ASA molding compositions (acrylonitrile/styrene/acrylate).

Another embodiment uses graft rubbers with up to 60% by weight residual water content based on polydienes and/or polyalkyl acrylates and also SAN and/or PMMA, where these involve more than two grafts.

Examples of these multigraft particles are particles comprising a polydiene and/or polyalkyl acrylate as core, a polystyrene or SAN polymer as first shell and another SAN polymer with an altered styrene:acrylonitrile ratio by weight as second shell, or else particles made of a polystyrene core, polymethyl methacrylate core or SAN-polymer core, of a first shell made of polydiene and/or polyalkyl acrylate and of a second shell made of polystyrene, polymethyl methacrylate or SAN polymer. Another example is graft rubber made of a polydiene core, of one or more polyalkyl acrylate shells and of one or more polymer shells made of polystyrene, polymethyl methacrylate or SAN polymer or analogously constructed graft rubbers with acrylate core and polydiene shells.

Other familiar materials are copolymers with multistage core-shell structure made of crosslinked alkyl acrylate, styrene, and methyl methacrylate and of an exterior shell made of PMMA. Such multistage graft rubbers are described by way of example in DE-A 31 49 046. Graft rubbers based on n-butyl acrylate/styrene/methyl methacrylate with a shell made of PMMA are described by way of example in EP-A 512 333, but it is also possible here to use any other construction corresponding to the prior art for these graft rubbers. Rubbers of this type are used as impact-modifying component for polyvinyl chloride and preferably for impact-resistant PMMA.

Again, it is preferable to use SAN copolymers and/or PMMA as polymer matrix A. If the further component B is a core/shell polymer of multishell structure based on n-butyl acrylate/methyl methacrylate and the polymer matrix A is PMMA, the resultant material is impact-resistant PMMA.

The diameter of the particulate graft rubbers is from 0.05 μm to 20 μm. If these are the well known small-diameter graft rubbers, said diameter is preferably from 80 nm to 600 nm and particularly preferably from 100 nm to 600 nm. In the case of the large-particle graft rubbers advantageously produced by means of suspension polymerization the diameter is preferably from 1.8 μm to 18 μm and in particular from 2 μm to 15 μm. These large-diameter graft rubbers are taught by way of example in DE-A 44 43 886. Preferred embodiments of the polymer matrix A in this embodiment are again the abovementioned SAN copolymers, polystyrene and/or PMMA.

The further component C is further polymers, in particular thermoplastic polymers. Any of the polymers mentioned for the polymer matrix A can be used for the further component C.

The polymer matrix A generally differs from the further component C by virtue of the monomers used.

If the monomers of which the polymer matrix A and the further component C are composed are identical, the polymer matrix A and the further component C generally differ by virtue of the quantitative proportions of the monomers. By way of example, the polymers B and C can be styrene-acrylonitrile copolymers differing in the ratio of styrene to acrylonitrile. In the event that the quantitative proportions of the monomers are also identical, the polymer matrix A and the further component C differ by virtue of their different average molar masses Mw (B) and Mw (C), measurable by way of example as different intrinsic viscosities IV (B) and IV (C).

Production of the further component C can also use the following other compounds as substantial constituent monomers alongside the monomers styrene, acrylonitrile, methyl methacrylate and vinyl chloride mentioned inter alia for component B: —α-methylstyrene and C1 to C8-ring-alkylated styrenes and, respectively, α-methylstyrenes, —methacrylonitrile, —C1 to C12-alkyl esters of acrylic acid and of methacrylic acid—maleic acid, maleic anhydride, and also maleimides—vinyl ether, vinyl formamide.

The following may be mentioned by way of example for the further component C: polymers based on α-methylstyrene/acrylonitrile and methyl methacrylate/alkyl acrylate, and also copolymers of alkyl esters of acrylic acid or of methacrylic acid and styrene or acrylonitrile or styrene and acrylonitrile. Other preferred further components C are styrene-acrylonitrile copolymers with quantitative proportions of the monomers differing from those of component B, or with different average molar masses Mw. Mw is determined by familiar methods.

Mentioned may be made of the following: copolymers of α-methylstyrene and acrylonitrile, polymethyl methacrylates, polycarbonates, polybutylene terephthalate and of polyethylene terephthalate, polyamides, copolymers of at least two of the monomers styrene, methyl methacrylate, maleic anhydride, acrylonitrile and maleimides, for example copolymers of styrene, maleic anhydride and phenylmaleimide, ABS produced by bulk polymerization or solution polymerization, thermoplastic polyurethanes (TPU). Production of these polymers is known to the person skilled in the art, and therefore only brief details thereof are given below.

The term polymethyl methacrylates in particular means polymethyl methacrylate (PMMA) and also copolymers based on methyl methacrylate with up to 40% by weight of other copolymerizable monomers, these materials being obtainable by way of example as Plexiglas from Evonik. Mention may be made, merely by way of example, of a copolymer of 98% by weight of methyl methacrylate and 2% by weight of methyl acrylate as comonomer (Plexiglas 8N, Evonik). An equally suitable material is a copolymer of methyl methacrylate with styrene and maleic anhydride as comonomers (Plexiglas HW55, Evonik).

Suitable polycarbonates are known per se. They can be obtained by way of example by the process of DE-B-1 300 266 via interfacial polycondensation or by the process of DE-A-14 95 730 via reaction of diphenyl carbonate with bisphenols. Preferred bisphenol is 2,2-di(4-hydroxyphenyl)propane, generally termed bisphenol A. It is also possible to use other aromatic dihydroxy compounds instead of bisphenol A, in particular 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane or 4,4-dihydroxydiphenyl and also mixtures of the abovementioned dihydroxy compounds. Particularly preferred polycarbonates are those based on bisphenol A or bisphenol A together with up to 30 mol % of the abovementioned aromatic dihydroxy compounds. Polycarbonates are obtainable by way of example with trade names Makrolon (Bayer), Lexan (SABIC IP), Panlite (Tejin) or Calibre (Dow). The relative viscosity of these polycarbonates is generally in the range from 1.1 to 1.5, in particular from 1.28 to 1.4 (measured at 25° C. in 0.5% by weight solution in dichloromethane).

Polybutylene terephthalate and polyethylene terephthalate are generally produced in a manner known per se via condensation of terephthalic acid or esters thereof with butanediol and, respectively, ethanediol, with catalysis. The condensation here is advantageously carried out in two stages (precondensation and polycondensation). Details can be found by way of example in Ullmann's Encyclopadie der Technischen Chemie [Ullmann's Encyclopedia of Industrial Chemistry], 4th edn., vol. 19, pp. 61 to 88. Polybutylene terephthalate is obtainable commercially by way of example as Ultradur (BASF).

Preferred polyamides are very generally those with any type of aliphatic semicrystalline or semiaromatic or else amorphous structure and blends of these. Corresponding products are obtainable by way of example with the trade name Ultramid (BASF).

Thermoplastic polyurethanes are usually produced via reaction of organic, preferably aromatic diisocyanates such as diphenylmethane 4,4′-diisocyanate with polyhydroxy compounds which are preferably in essence linear, for example polyetherols, or polyesterols such as polyalkylene glycol polyadipates, and diols acting as chain extenders, for example butane-1,4-diol, in the presence of catalysts such as tertiary amines (for example triethylamine) or organometallic compounds. The ratio of NCO groups of the diisocyanates to the entirety of the OH groups here (from the polyhydroxy compounds and the chain-extending diols) is preferably about 1:1.

TPU are preferably produced by what is known as the belt process, where the components mentioned and the catalyst are mixed continuously by means of a mixing head and the reaction mixture is applied to a conveyor belt. The belt passes through a zone with the temperature controlled to from 60° C. to 200° C., where the mixture completes its reaction and solidifies. Details concerning TPU can be found by way of example in EP-A 443 432. TPU are obtainable by way of example with the trade name Elastollane (Elastogran).

The further component C can moreover consist essentially of copolymers of C2- to C9-alkenes such as ethylene, propene and butene with vinylaromatics, polar comonomers such as acrylic acid and methacrylic acid, the C1- to C12-alkyl esters of acrylic acid and of methacrylic acid, other mono- or polyfunctional ethylenically unsaturated acids such as maleic acid, maleic anhydride, fumaric acid, itaconic acid and also esters thereof, in particular glycidyl esters, esters with C1- to C9-alkanols and esters with acrylic-substituted C1- to C9-alkanols, carbon monoxide, non-aromatic vinyl compounds such as vinyl acetate, vinyl propionate and vinyl alkyl ethers, basic monomers such as hydroxyethyl acrylate, dimethylaminoethyl acrylate, vinylcarbazole, vinylaniline, vinylcaprolactam, vinylpyrrolidone, vinylimidazole and vinylformamide, acrylonitrile, methacrylonitrile, these being produced in a well known manner.

One preferred embodiment uses a further component C which can be produced from 40 to 75% by weight of ethylene, from 5 to 20% by weight of carbon monoxide and from 20 to 40% by weight of n-butyl acrylate (obtainable commercially as Elvaloy E HP-4051 (DuPont)), or a polymer that can be produced from 50 to 98.9% by weight of ethylene, from 1 to 45% by weight of n-butyl acrylate and from 0.1 to 20% by weight of one or more other compounds selected from the group of acrylic acid, methacrylic acid and maleic anhydride. Production of the last-mentioned embodiments is usually achieved by free-radical polymerization and is described in the documents U.S. Pat. No. 2,897,183 and U.S. Pat. No. 5,057,593.

Other suitable materials are copolymers of butadiene or of substituted butadienes with styrene, methyl methacrylate or acrylonitrile, an example being nitrile rubber (NBR) or styrene-butadiene rubber (SBR). The olefinic double bonds in these copolymers can have been hydrogenated entirely or to some extent.

Materials equally optionally suitable as further component C are hydrogenated or to some extent hydrogenated copolymers of butadiene and styrene with block structures. They are preferably produced by the anionic polymerization methods in solution with use of organometallic compounds such as sec-butyllithium, the products being linear block rubbers having by way of example styrene/butadiene (two-block) structure or styrene-butadiene/styrene (three-block) structure. There can be polymers with random distribution separating these blocks from one another, and the blocks can moreover also comprise subordinate quantities of units of the respective other monomers.

If small quantities of an ether, in particular tetrahydrofuran (THF), are used alongside the initiator, polymer chains are produced which, starting from a butadiene-rich initial segment, have increasing styrene content along the chain and finally terminate in a terminal homopolystyrene segment. Details of the production process are described in DE-A 31 06 959. Optionally hydrogenated or to some extent hydrogenated further components C having this type of structure also have good suitability.

Polymers with star-shaped structure have equally good suitability as further component C, these being primarily obtained via linkage of a plurality of polymer chains, mainly of three-block polymers of styrene/butadiene/styrene type, by way of polyfunctional molecules. Examples of suitable linking agents are polyepoxides, for example epoxidized linseed oil, polyisocyanates such as benzene 1,2,4-triisocyanate, polyketones such as 1,3,6-hexanetrione and polyanhydrides, and also dicarboxylic esters such as diethyl adipate, and also silicon halides such as SiCl₄, metal halides such as TiCl₄ and polyvinylaromatics such as divinylbenzenes. Further details concerning production of these polymers can be found by way of example in DE-A 26 10 068.

The thermoplastic molding compositions produced by the process of the invention can also comprise, alongside the polymer matrix A and the microspheres M and optionally further components B and C, additives as further component D, for example waxes, plasticizers, lubricants and mold-release agents, optionally further pigments and dyes, matting agents, flame retardants, antioxidants, stabilizers to counter the effective light and to counter thermal degradation, and optionally small quantities of fibrous and pulverulent fillers and fibrous and pulverulent reinforcing agents, and antistatic agents, quantities generally being those usual for these materials.

The additives D can be in pure solid, liquid or gaseous form, or can be used in a form in which the pure substances have already been mixed with one another. The quantity added of these is often from 0.1 to 4.9% by weight, based on the entire molding composition. They can equally be used in a formulation which facilitates metering, for example as solution or as dispersion (emulsion or suspension). A formulation as masterbatch is also suitable and in some cases is preferred.

In another preferred embodiment, the thermoplastic molding composition comprises from 50 to 95% by weight, often from 65 to 95% by weight, of a styrene-acrylonitrile copolymer and from 0.1 to 30% by weight, preferably from 0.5 to 5% by weight, of solid particles F in the form of metal particles. The location of these metal particles is (at least predominantly, e.g. to an extent of at least 90%) within the microspheres M.

In another preferred embodiment, the thermoplastic molding composition comprises from 1 to 70% by weight of at least one rubber-modified styrene-acrylonitrile copolymer, where the rubber component is based on an acrylate-styrene-acrylonitrile copolymer or on a polybutadiene.

The invention also provides a thermoplastic molding composition comprising, in each case based on the total weight of the molding composition, from 60 to 95% by weight of a polymer matrix A made of at least one styrene copolymer, and also from 0.1% by weight to 30% by weight of platelet-shaped solid particles F located in a large number of microspheres M with average particle diameter of the microspheres M less than 100 μm, where the microspheres M comprise a copolymer and in each case a platelet-shaped solid particle F, where the refractive indices of the styrene copolymer of the polymer matrix A and of the copolymer of the microspheres M differ from one another by less than 0.5%.

The thermoplastic molding composition is produced by providing the polymer matrix A and also microspheres M comprising at least one, preferably precisely one solid particle F, and uniformly mixing or uniformly compounding the microspheres M comprising the solid particles with the polymer matrix A. An alternative embodiment introduces at least one, preferably precisely one solid particle F into the microspheres M during a polymerization for the production of the microspheres M, thus producing microspheres M comprising solid particle(s) and which are then uniformly mixed with, or compounded with, the polymer matrix A.

The thermoplastic molding composition can be processed by the processes that are generally conventional to give moldings, foils or coatings. Mention may be made by way of example of extrusion (for pipes, profiles, fibers, foils and sheets), injection molding (for moldings of any type) and also calendering and rolling (for sheets and foils).

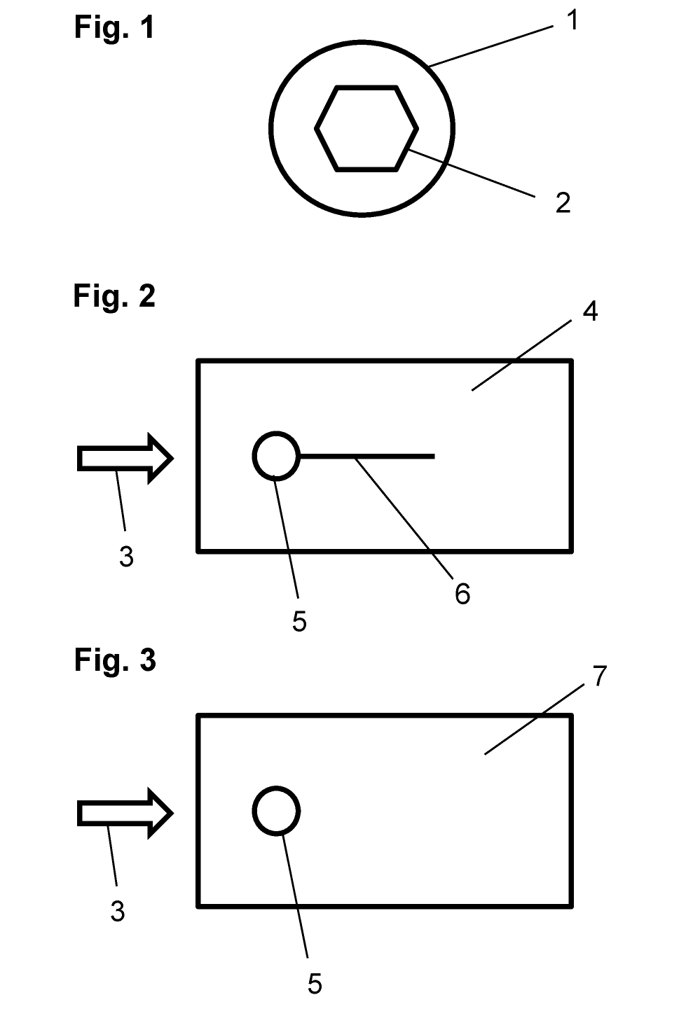

FIG. 1 is a schematic diagram of a microsphere (M) 1 which comprises precisely one metal particle (F) 2 (platelet, Al flake).

FIG. 2 is a detail of a thermoplastic component produced from a traditional thermoplastic molding composition 4 of the prior art. The production process involved introduction of the thermoplastic molding composition by way of the inlet 3 and flow of said composition around the shaper insert 5. When a thermoplastic molding composition 4 of the prior art is used here there is a visible polymer front 6, because the solid particles F used, for example metal flakes, comprising the special-effect materials E have become oriented along the direction of flow of the thermal polymer composition 4; undesired optical effects are produced.

FIG. 3 is a schematic diagram of a component of the invention, produced from a thermoplastic molding composition 7 of the invention. There is no polymer front visible here, even when the thermoplastic molding composition 7 encloses a shaper insert 5, because the solid particles F, each of which is enclosed by a microsphere M, are not oriented by the direction of flow of the thermoplastic molding composition.

### COMPARATIVE EXAMPLE AND INVENTIVE EXAMPLE

### Comparative Example

1% by weight of aluminum flakes with maximal spatial dimension 8 μm is added to a transparent thermoplastic molding composition with main constituents SAN and ASA in order to achieve a metallic (optical) effect of the thermoplastic molding composition.

The composition can by way of example comprise 90% by weight of commercially available SAN (such as Luran® 358 from Styrolution) and also 9% by weight of ASA (such as Luran®S from Styrolution).

When this thermoplastic molding composition comprising aluminum flakes is further processed by means of injection molding, flow lines become visible at shaper inserts because of spatial orientation of the aluminum flakes along the direction of flow of the thermoplastic molding composition. This leads to a molding that is visually nonuniform.

### Inventive Example

The quantity of aluminum flakes with maximal spatial dimension of 8 μm added to the transparent thermoplastic molding composition is the same as in the comparative example, but with the difference that the aluminum flakes are not introduced directly into the thermoplastic molding composition.

Transparent microspheres with diameter about 10 μm are first produced, each of these microspheres comprising one of the aluminum flakes. The microspheres are produced (with a shell) made of a transparent material which is PS/PMMA-based and has been crosslinked, and which has a refractive index very similar to that of the abovementioned thermoplastic molding composition (SAN, ASA) (difference<0.5%).

The microspheres have been filled with the transparent copolymer material (see above) and completely enclose the respective aluminum flake. The microspheres comprising the aluminum flakes are then added to the thermoplastic molding composition. The microspheres become distributed in the molding composition and the shape of the microspheres is retained and is unaltered after addition to the thermoplastic molding composition.

Surprisingly, when this thermoplastic molding composition of the invention, comprising aluminum flakes encapsulated in microspheres, is further processed by means of injection molding, the transparency of the thermoplastic molding composition is almost entirely retained. The flow lines at shaper inserts are not, or hardly, discernible.

There is no discernible spatial orientation of the aluminum flakes in the molding composition or in the molding. Unlike unencapsulated aluminum flakes, the encapsulated aluminum flakes retain high light reflectance, giving the thermoplastic molding composition a metallic luster.

Corresponding experiments can be carried out with other metal platelets and other styrene copolymer matrices and with small quantities (e.g. less than 1% by weight) of stabilizer addition.

1-15. (canceled)

16. A thermoplastic molding composition comprising a polymer matrix A and also a large number of microspheres M with, arranged in each of the microspheres M, at least one solid particle F.

17. The thermoplastic molding composition as claimed in claim 16, characterized in that the microspheres M in the thermoplastic molding composition have an unaltered spherical shape and the solid particles F are not spherical.

18. The thermoplastic molding composition as claimed in claim 16, characterized in that the polymer matrix A is composed of at least one transparent styrene (co)polymer and refractive indices of a material of the polymer matrix A and of a material for microspheres M differ from one another by less than 1.5%.

19. The thermoplastic molding composition as claimed in claim 16, characterized in that at least 60% by weight of the microspheres M, based on the entire material of the microspheres M, comprise glass.

20. The thermoplastic molding composition as claimed in claim 16, characterized in that the microspheres M have at least 60% by weight content, based on the entire material of the microspheres M, of a main material selected from a group consisting of uncrosslinked polymers such as polystyrene and crosslinked polymers such as polymethyl methacrylate, polystyrene copolymers and polycarbonate.

21. The thermoplastic molding composition as claimed in claim 16, characterized in that the solid particles F comprise special-effect materials E.

22. The thermoplastic molding composition as claimed in claim 16, characterized in that the solid particles F have more than 60% by weight content, based on the entire solid particle F, of special-effect materials E in particular selected from the group consisting of aluminum, silver, copper and brass.

23. The thermoplastic molding composition as claimed in claim 16, characterized in that the solid particles F have a surface that reflects at least 40% of the incident light.

24. The thermoplastic molding composition as claimed in claim 16, characterized in that the solid particles F have a flat shape and the shortest spatial dimension is less than 5 μm and the longest spatial dimension is more than 5 μm and less than 200 μm.

25. The thermoplastic molding composition as claimed in claim 16, characterized in that the average particle diameter of the microspheres M is less than 200 μm, and the largest spatial dimension of the solid particles F is precisely the same as or slightly smaller than the average particle diameter of the microspheres M.

26. The thermoplastic molding composition as claimed in claim 16, characterized in that the thermoplastic molding composition comprises, based in each case on the total weight of the thermoplastic molding composition, from 40% by weight to 95% by weight of the polymer matrix A comprising at least one transparent styrene (co)polymer, and also from 0.1% by weight to 30% by weight to solid particles F, and also optionally from 0.1% by weight to 4.9% by weight of auxiliaries and additives.

27. The thermoplastic molding composition as claimed in claim 16, characterized in that the thermoplastic molding composition comprises from 50 to 95% by weight of a styrene-acrylonitrile copolymer and from 0.1 to 30% by weight of solid particles F in the form of metal particles.

28. The thermoplastic molding composition as claimed in claim 16, characterized in that the thermoplastic molding composition comprises from 1 to 70% by weight of at least one rubber-modified styrene-acrylonitrile copolymer, where the rubber component is based on an acrylate-styrene-acrylonitrile copolymer (ASA) or on a polybutadiene (PB).

29. A process for the production of the thermoplastic molding composition as claimed in claim 16, characterized in that the polymer matrix A and also the microspheres M comprising at least one solid particle F are provided, and the microspheres M comprising solid particle(s) are uniformly mixed with, or uniformly compounded with, the polymer matrix A.

30. A molding, foil or coating comprising the thermoplastic molding composition as claimed in claim 16.

31. The thermoplastic molding composition as claimed in claim 16, comprising precisely one solid particle F.

32. The thermoplastic molding composition as claim in claim 18, wherein the refractive indices of a material of the polymer matrix A and of a material for microspheres M differ from one another by less than 0.5%.

33. The thermoplastic molding composition as claimed in claim 32, comprising precisely one solid particle F.

34. The thermoplastic molding composition as claimed in claim 25, wherein the average particle diameter of the microspheres M is less than 100 μm.

35. The process as claimed in claim 29, wherein the thermoplastic molding composition comprises precisely one solid particle F.
